(19) United States
(12) Patent Application Publication
(10) Pub. No.: US 2026/0279801 A1
(43) Pub. Date: Sep. 17, 2026

(54) POSITIVE ELECTRODE ACTIVE MATERIAL FOR SECONDARY BATTERY, POSITIVE ELECTRODE COMPRISING THE SAME, AND SECONDARY BATTERY COMPRISING POSITIVE ELECTRODE

(71) Applicants: HYUNDAI MOTOR COMPANY, Seoul (KR); KIA CORPORATION, Seoul (KR); GWANGJU INSTITUTE OF SCIENCE AND TECHNOLOGY, GWANGJU (KR)

(72) Inventors: Haeun Lee, Hwaseong-si (KR); Yonghoon Kim, Hwaseong-si (KR); Seung Won Lee, Gwangju (KR); Joo-Hyoung Lee, Gwangju (KR); Sang Hyun Kim, Gwangju (KR)

(73) Assignees: HYUNDAI MOTOR COMPANY, Seoul (KR); KIA CORPORATION, Seoul (KR); GWANGJU INSTITUTE OF SCIENCE AND TECHNOLOGY, GWANGJU (KR)

(21) Appl. No.: 19/260,151

(22) Filed: Jul. 3, 2025

(30) Foreign Application Priority Data
Mar. 11, 2025 (KR) 10-2025-0031229

(51) Int. Cl. H01M 4/58; H01M 4/02; H01M 10/0525

(52) U.S. Cl. CPC H01M 4/5825; H01M 10/0525; H01M 2004/028

(57) ABSTRACT

A positive electrode active material that can be used in a secondary battery includes a compound represented by Chemical Formula 1: LiₓMnFeP₃O₁₂ (wherein 0≤x≤4) [Chemical Formula 1], as well as positive electrodes and secondary batteries that include the active material.

### CROSS-REFERENCE TO RELATED APPLICATION

This present application claims the benefit of priority to Korean Patent Application No. 10-2025-0031229, filed on Mar. 11, 2025, in the Korean Intellectual Property Office, the entire disclosure of which is incorporated herein by reference.

### FIELD

The present disclosure relates to a positive electrode active material for a secondary battery, a positive electrode comprising the same, and a secondary battery comprising the positive electrode.

### BACKGROUND

As the utilization of smart devices gradually increases, demand for high-capacity secondary batteries is growing. Current secondary battery technology is predominantly based on lithium-ion secondary batteries, and the capacity of the battery is mainly determined by the positive electrode active material. The positive electrode active materials mainly used in commercialized lithium-ion secondary batteries include LiCoO₂, LiFePO₄, LiMn₂O₄, and active materials with improved compositions of these materials.

However, cobalt (Co), which is a core element of the positive electrode active material, has a geopolitical supply instability risk due to its concentration in specific countries. Further, Li—Fe—P series positive electrode active materials have lower energy density and capacity relative to Li—Co—O positive electrode active materials. These factors, among others, potentially limits the advancement of positive electrode materials.

In order to address these issues and strengthen the competitiveness of the secondary battery material market, there is an urgent need to develop new high-performance secondary battery positive electrode active materials.

### SUMMARY

The present disclosure provides a positive electrode active material for a secondary battery with high energy density and average voltage using quantum mechanics-based computational materials science methodology and neural network-based machine learning, a positive electrode comprising the same, and a secondary battery comprising the positive electrode.

The present disclosure also provides a positive electrode active material for a secondary battery that may secure improved positive electrode material performance compared to commercial positive electrode active material (e.g., LiFePO₄), a positive electrode comprising the same, and a secondary battery comprising the positive electrode.

A positive electrode active material for a secondary battery according to some aspects and embodiments of the present disclosure may include a compound represented by Chemical Formula 1:

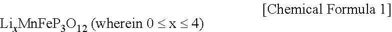

In some embodiments relating to the positive electrode active material for a secondary battery, the compound may be represented by Chemical Formula 2:

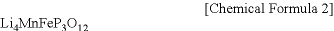

In some embodiments relating to the positive electrode active material for a secondary battery, the compound may be represented by Chemical Formula 3:

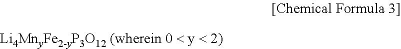

In some aspects, the disclosure relates to a positive electrode including the positive electrode active material according to the various aspects and embodiments described herein.

In some aspects, the disclosure relates to a lithium ion secondary battery including the positive electrode or the positive electrode active material, according to the various aspects and embodiments described herein.

In some embodiments, a novel lithium iron phosphate positive electrode material according to the present disclosure has high energy density and average voltage.

In some embodiments, the average discharge voltage of the novel positive electrode active material for a secondary battery according to the present disclosure is significantly higher than the average discharge voltage of the existing commercially available LiFePO₄. Accordingly, the positive electrode active material according to various embodiments of the present disclosure has potential for high-voltage applications.

In some embodiments, the gravimetric energy density and volumetric energy density of the novel positive electrode active material for a secondary battery according to the present disclosure are significantly higher than those of LiFePO₄.

The advantages and effects of the present disclosure are not limited to those mentioned above, and other advantages and effects not mentioned can be clearly understood by those skilled in the art from the following description.

### BRIEF DESCRIPTION OF THE DRAWINGS

The foregoing and other aspects, features, and advantages, as well as the following detailed description of the embodiments, will be better understood when read in conjunction with the accompanying drawings, which illustrate some exemplary aspects and embodiments of the disclosure. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 depicts and embodiment of a schematic diagram of a model used to search for candidate materials for a positive electrode active material for a secondary battery and to evaluate their properties.

FIG. 2A shows prediction results of formation energy according to Li ion concentration, and FIG. 2B shows a voltage change of Li₄MnFeP₃O₁₂ according to Li ion insertion, both in accordance with example embodiments of the disclosure.

FIG. 3 shows calculation results of volume change rate of a positive electrode active material in accordance with example embodiments of the disclosure.

FIG. 4 shows a crystal structure of Li₄MnFeP₃O₁₂, an exemplary novel positive electrode active material in accordance with example aspects and embodiments of the disclosure.

### DETAILED DESCRIPTION

The various aspects and embodiments described in the present specification can be modified into various other forms, and the technology according to exemplary embodiments is not limited to those particular embodiments described below. The exemplary embodiments are provided merely in an attempt to make the description of the present disclosure thorough, and to fully convey the scope of the present disclosure to those skilled in the art.

Singular forms “a,” “an,” and “the” used in the specification and the appended claims are intended to include plural referents unless the context clearly dictates otherwise.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

In the present disclosure, it should be understood that term “comprising” or “having” or “including” (and similar inclusive terms) indicates that a feature, a number, a step, an operation, an element, a component, a part or a combination thereof described in the specification is present, but does not exclude a possibility of the presence or addition of one or more other features, numbers, steps, operations, elements, components, parts or combinations thereof, in advance. It will be appreciated that those terms are also inclusive of the term “consisting of” or “consisting essentially of” which particular terms, when used throughout the disclosure or claims, generally indicate that a feature, a number, a step, an operation, an element, a component, a part or a combination thereof described in the specification is present, and does not include any additional feature(s), etc.

Furthermore, terms including ordinals such as first, second, etc. may be used to describe various elements, but the elements are not limited by these terms. These terms are only used to distinguish one constituent element from another.

Recently, various studies using density functional theory (DFT) and other methods have been conducted to develop positive electrode active materials capable of high capacity. However, calculations of the performance of electrodes for secondary batteries using these methods have limitations due to high computational costs arising from quantum mechanical characteristics and insufficient results due to intuition-based inputs. Recently, there have been attempts to overcome such limitations through machine learning (ML) using artificial neural networks (ANN). Notably, a crystal graph convolutional neural network (CGCNN) module can be used to extract and derive alternative positive electrode active materials with high energy density and minimal volume change.

The physical properties of the positive electrode of a secondary battery, such as energy density and voltage curves, are determined by electrochemical reactions, and to accurately predict these electrochemical reactions, the chemical potential difference between the intercalated state and the deintercalated state must be calculated simultaneously. However, the CGCNN module still has limitations in deriving alternative positive electrode active materials because it operates without considering these two states.

Further complicating the advancement of these materials, Co, which is a core element of the positive electrode active material, is exposed to geopolitical supply instability risk due to its concentration in specific countries, while Li—Fe—P series positive electrode active materials have lower energy density and capacity compared to Li—Co—O positive electrode active materials. For example, the theoretical gravimetric capacity of the existing LiFePO₄ positive electrode material used in secondary batteries is 169.9 mAh/g, which is lower than that of NCM series (e.g., NiMnCo oxides) positive electrode materials. In addition, for LiFePO₄, the theoretical average voltage is 3.52V, the theoretical gravimetric energy density is 594.5 Wh/kg, and the theoretical volumetric energy density is 2063.4 Wh/l.

Accordingly, there is a need to secure new iron phosphate-based positive electrode active materials to strengthen the competitiveness of next-generation secondary battery positive electrode materials.

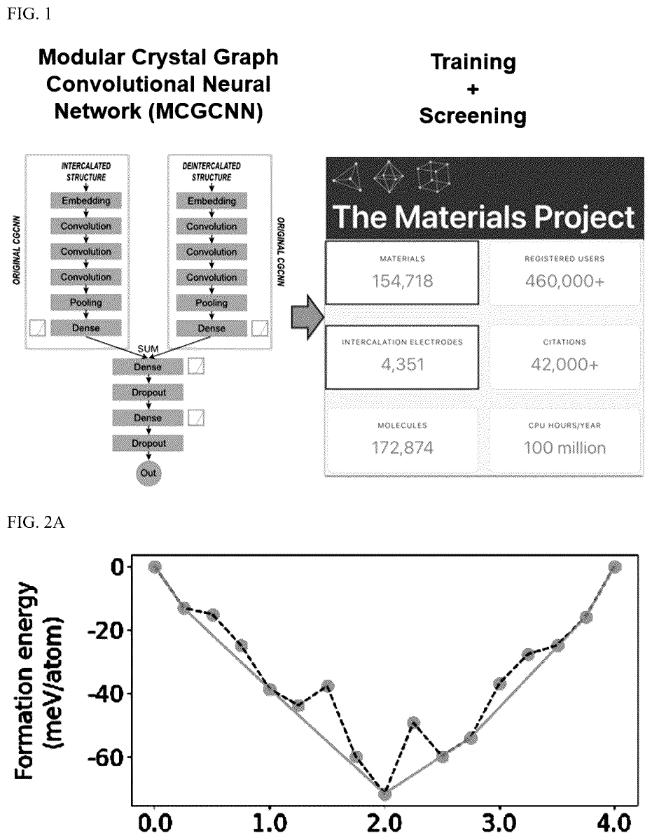

FIG. 1 provides a schematic diagram of a model that can be used to search for candidate materials for a positive electrode active material for a secondary battery and to evaluate their properties.

In accordance with some example aspects and embodiments of the present disclosure, as shown in FIG. 1, candidate materials for positive electrode active materials for secondary batteries were searched and their properties were evaluated by training a MCGCNN model using a newly proposed modular crystal graph convolutional neural network (MCGCNN) module, which includes two independent CGCNN modules and a post-processing device, and the positive electrode material database of the Materials Project.

In accordance with aspects and embodiments of the present disclosure, a positive electrode active material with high energy density and average voltage was derived using quantum mechanics-based computational materials science methodology and neural network-based machine learning.

In some further embodiments, the positive electrode active material for a secondary battery according to the present disclosure may comprise a compound represented by Chemical Formula 1:

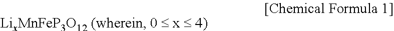

In some further embodiments, the positive electrode active material for a secondary battery according to the present disclosure may comprise a compound represented by Chemical Formula 2:

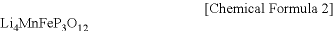

In some further embodiments, the positive electrode active material for a secondary battery according to the present disclosure may comprise a compound represented by Chemical Formula 3:

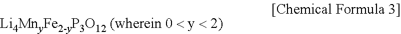

In various embodiments, a novel lithium iron phosphate positive electrode material according to the present disclosure has high energy density and average voltage.

In some embodiments, the average discharge voltage of the novel positive electrode active material for a secondary battery according to the present disclosure is significantly higher than the average discharge voltage of the existing commercially available LiFePO₄. Accordingly, the positive electrode active material according to embodiments of the present disclosure has potential for high-voltage applications.

In some further embodiments, the gravimetric energy density and volumetric energy density of the novel positive electrode active material for a secondary battery according to the present disclosure are significantly higher than those of LiFePO₄.

Additional aspects and embodiments in accordance with the present disclosure will now be described in more detail.

### 1. Derivation of Positive Electrode Active Material Candidate Materials

A modular crystal graph convolutional neural network (MCGCNN) module based on artificial neural networks was created for material property prediction.

A MCGCNN model was trained using the positive electrode material database of the Materials Project, which contains information on 4,904 battery materials.

Among 154,718 inorganic materials searched from the Materials Project, 780 materials containing Li—Fe—P—O were selected, and the trained MCGCNN model was applied to predict battery performance based on average voltage.

Considering the structural stability of the battery material, the prediction range of the average voltage of the MCGCNN model was set to 4V or more and 4.5V or less.

Considering the theoretical energy density of LiFePO₄, which is 595 Wh/kg, the target energy density was set to 700 Wh/kg, and after excluding previously reported materials, a new LFP positive electrode material, Li₄MnFeP₃O₁₂, was derived.

Meanwhile, the active material-related data described in the present disclosure were searched for candidate materials for positive electrode active materials by accessing the Materials Project database through the REST API of the Materials Project, and were searched by receiving data on intercalation electrodes with calculated battery characteristics, such as gravimetric and volumetric energy densities, from the Materials Project.

In support of the prediction by the MCGCNN module, the properties of the positive electrode active material were also calculated using a first-principles calculation program called VASP (Vienna Ab initio Simulation Package), and with the same calculation standards applied to the Materials Project.

### 2. Theoretical Verification

### (1) First-Principles Calculations

First-principles calculations based on density functional theory (DFT) were performed to calculate the performance of Li—Fe—P series battery candidate materials. The first-principles calculations were performed using the VASP (Vienna Ab-initio Simulation Package) software, which implements a projector-augmented-wave (PAW) method, and the calculation results are shown in Table 1 below. In Table 1, Voltage represents the average voltage, C_{gra} represents the gravimetric energy density, Cᵥₒₗ represents the volumetric energy density, and ΔVₘₐₓ represents the volume change rate.

TABLE 1

| Chemical | Voltage | C_{gra} | Cᵥₒₗ | ΔVₘₐₓ |
|---|---|---|---|---|
| Formula | (V) | (mAh/g) | (Ah/L) | (%) |
| Li₄MnFeP₃O₁₂ | 4.4 | 252 | 728 | 8.3 |

More detailed first-principles calculation experiments on the properties of Li—Fe—P series battery candidate materials specified in Table 1 above are described in the Experimental Example and Experimental Results sections below. In the Experimental Example, the electron exchange correlation energy function accompanying the first-principles calculation was represented by generalized gradient approximation (GGA) as proposed by Perdew, Burke, and Enzerhof, and the kinetic energy cutoff for the representation of the Kohn-Sham wave function was set to 520 eV.

### (2) Formation Energy and Voltage Calculation

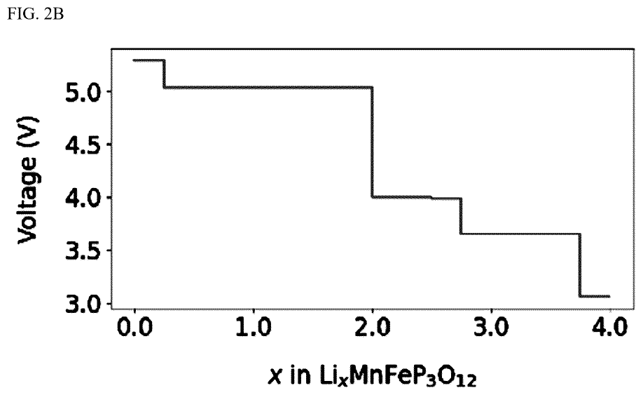

To calculate the voltage distribution according to Li insertion, the formation energy according to Li ion concentration was predicted by applying a CGCNN model. The results are shown in FIG. 2A.

After selecting the structure showing the minimum formation energy at each Li ion concentration, the voltage was calculated using the following Equation 1:

$$V = - \frac{\begin{matrix}E [ {Li}_{x 1} {MnFeP}_{3} {O}_{12} ] - \\ E [ {Li}_{x 2} {MnFeP}_{3} {O}_{12} ] - ( {x}_{1} - {x}_{2} ) E [ Li ]\end{matrix}}{( {x}_{1} - {x}_{2} ) F} \qquad [ Equation 1 ]$$

In Equation 1, E [LixMnFeP₃O₁₂] and E[Li] represent the ground state energy of the positive electrode active material with x Li ion concentration and metallic phase Li, respectively, obtained through quantum mechanics calculations, and F is the Faraday constant.

FIG. 2B shows the voltage change of Li₄MnFeP₃O₁₂ according to Li ion insertion. It was confirmed that Li₄MnFeP₃O₁₂ shows a voltage of 5.3V at the maximum charging condition, and the voltage gradually decreases during the discharge process, showing a voltage of 3V at the maximum discharge condition, resulting in a total average voltage of 4.4V.

### Experimental Example

The candidate material model used in the Experimental Example is Li₄MnFeP₃O₁₂, where 4 formula units form 1 unit cell, and 16 Li atoms exist in the unit cell.

To investigate the battery performance of Li₄MnFeP₃O₁₂, first-principles calculations are performed on all structures occurring during the complete deintercalation-intercalation of Li ions and their intermediate processes (0≤x≤4) for Li₄MnFeP₃O₁₂. Accordingly, for this, a 3×3×2 gamma-centered k-point sampling generated by the Monkhorst-Pack scheme in the first Brillouin zone was applied.

To perform first-principles calculations on structures occurring during the deintercalation-intercalation process of Li ions, the energetically most stable structure must be secured at each process. To this end, the possible arrangements of Li ions were listed through electrostatic energy filtering, and the structure of the ground state showing the lowest energy was adopted to calculate the battery characteristics.

### Experimental Results

To investigate the structural stability of the Li₄MnFeP₃O₁₂ positive electrode active material according to charge-discharge, the range of Li ion deintercalation-intercalation [Li₄MnFeP₃O₁₂ (0≤x≤4)] was divided into 17 sections according to the Li composition ratio (x), and the volume of the positive electrode active material was calculated for each composition ratio.

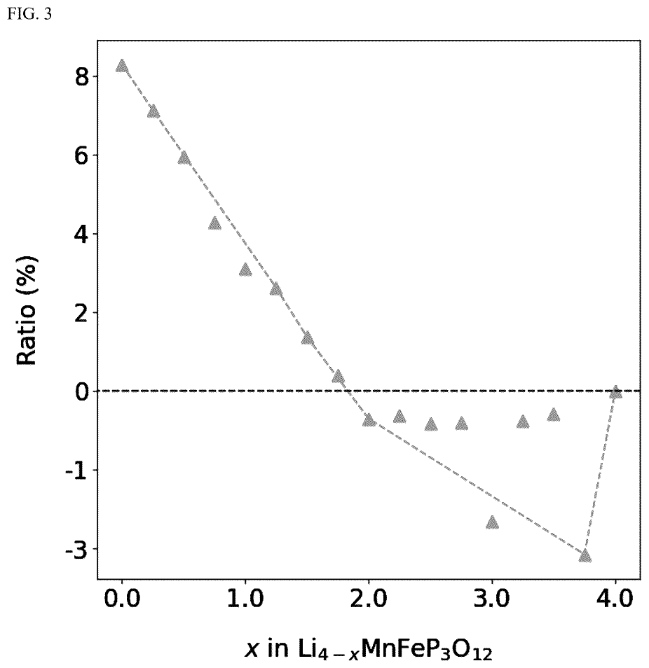

The volume change rate (ΔVmax) of the positive electrode active material can be defined by Equation 2 below using the volume (V) of the structure occurring during the deintercalation-intercalation process of the working ion and the volume (V_{deintercalation}) of the positive electrode active material in the complete deintercalation state, and the calculated results are shown in FIG. 3.

$$Δ Vmax ( \% ) = [ \frac{V}{Vdeintercalation} - 1 ] \times 100 \qquad [ Equation 2 ]$$

In addition, to confirm the discharge voltage (V) of the positive electrode active material, which is a functionally relevant characteristic of a battery, the discharge voltage for each section [Lix1MnFeP₃O₁₂, Lix2MnFe P₃O₁₂] was calculated according to Equation 1 above using the first-principles calculation results.

The average discharge voltage of the Li—Fe—P secondary battery positive electrode active material Li₄MnFeP₃O₁₂ according to the present disclosure was determined to be 4.4V, which is about 26% higher than the average discharge voltage of 3.5V of the existing commercially available LiFePO₄. Accordingly, it was confirmed that the positive electrode active material according to the present disclosure has applicability for high-voltage applications.

The theoretical specific capacity and volumetric capacity of the Li₄MnFeP₃O₁₂ positive electrode active material were calculated to be 252 mAh/g and 728 Ah/L, respectively, through Faraday's law. Specifically, the theoretical specific capacity is calculated by Equation 3:

$$( Number of Li ions \times Faraday constant ) / ( 3600 \times molecular weight of the compound ) \qquad [ Equation 3 ]$$

Additionally, the volumetric capacity is calculated by multiplying the theoretical specific capacity calculated according to Equation 3 by the molecular weight of the compound, and then dividing by the volume.

Multiplying these values by the average discharge voltage of 4.4V yields a gravimetric energy density of 1110 Wh/kg and a volumetric energy density of 3205 Wh/L. It can be seen that this far exceeds the gravimetric energy density of 594 Wh/kg and the volumetric energy density of 2063 Wh/L of the existing LiFePO₄ material.

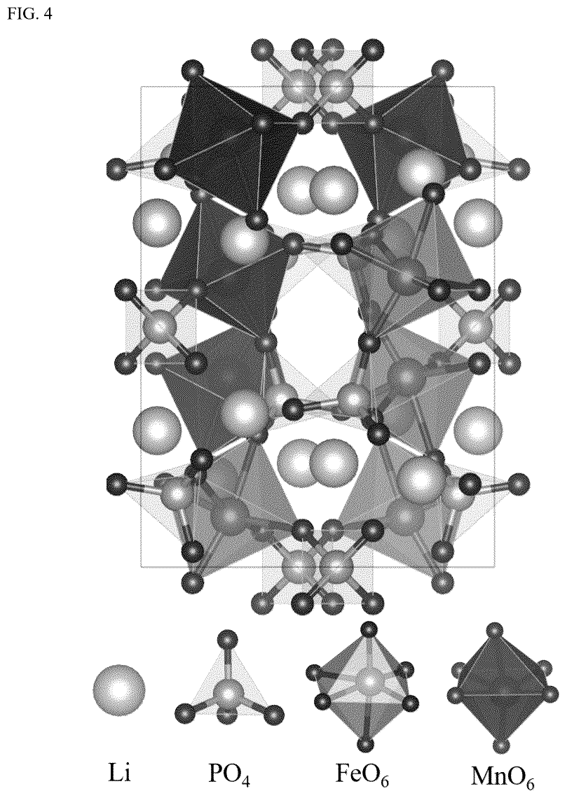

FIG. 4 shows a crystal structure of Li₄MnFeP₃O₁₂, which is a novel positive electrode active material in accordance with, and derived from exemplary aspects and embodiments of the present disclosure.

Li₄MnFeP₃O₁₂ has a space group of Pbcn, and Fe atoms and Mn atoms form octahedra by combining with 6 oxygen atoms.

As confirmed above, the average voltage of the Li ion insertion process of Li₄MnFeP₃O₁₂ is 4.4V, and the gravimetric energy density and the volumetric energy density were confirmed to be 1110.6 Wh/kg and 3205.1 Wh/L, respectively.

These properties are improved compared to LiFePO₄, which has an average voltage of 3.52V, a gravimetric energy density of 594.5 Wh/kg, and a volumetric energy density of 2063.4 Wh/l.

In order to rationally design a new positive electrode active material, variation and optimization of one or more several parameters such as minimum volume change, flat discharge curve, and high energy density can provide valuable guidance. As described herein, the positive electrode active materials for secondary batteries derived according to the various aspects and embodiments of the present disclosure have great technical significance in that they satisfy at least one or more of the above parameters.

Embodiments of the present disclosure have been described above with reference to the drawings. As noted herein, these drawings are exemplary in nature, and the present disclosure is not limited to the embodiments and the content of the drawings described above.

It will be apparent to those skilled in the art that modifications can be made to the present disclosure within the scope of the disclosed technical information, advancements, and/or ideas. The described aspects and embodiments form part of the present disclosure, but the scope of the present disclosure should not be defined solely by the described aspects and embodiments.

Further, in the description of the aspects and embodiments of the present disclosure, even if actions or effects according to the configuration are not explicitly described, actions or effects that can be predicted from the described configurations should also be understood as included in the present disclosure.

What is claimed is:

1. A positive electrode active material comprising a compound represented by Chemical Formula 1:

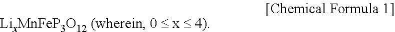

2. The positive electrode active material of claim 1, wherein the compound is represented by Chemical Formula 2:

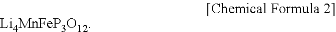

3. A positive electrode active material comprising a compound represented by Chemical Formula 3:

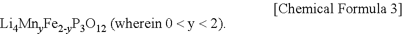

4. A positive electrode comprising the positive electrode active material of claim 1.

5. A positive electrode comprising the positive electrode active material of claim 2.

6. A positive electrode comprising the positive electrode active material of claim 3.

7. A lithium ion secondary battery comprising the positive electrode of claim 4.

8. A lithium ion secondary battery comprising the positive electrode of claim 5.

9. A lithium ion secondary battery comprising the positive electrode of claim 6.

10. A lithium ion secondary battery comprising the positive electrode material of claim 1.

11. A lithium ion secondary battery comprising the positive electrode material of claim 2.

12. A lithium ion secondary battery comprising the positive electrode material of claim 3.
